(19) United States
(12) Patent Application Publication
(10) Pub. No.: US 2025/0126562 A1
(43) Pub. Date: Apr. 17, 2025

(54) SIMULTANEOUS LINK OPERATION FOR MULTI-LINK DEVICES

(71) Applicant: Samsung Electronics Co., Ltd., Suwon-si (KR)

(72) Inventors: Rubayet Shafin, Allen, TX (US); Boon Loong Ng, Plano, TX (US); Vishnu Vardhan Ratnam, Plano, TX (US); Peshal Nayak, Plano, TX (US); Yue Qi, Plano, TX (US); Elliot Jen, Taipei City (TW)

(21) Appl. No.: 18/902,832

(22) Filed: Sep. 30, 2024

Related U.S. Application Data
(60) Provisional application No. 63/543,857, filed on Oct. 12, 2023.

(51) Int. Cl. H04W 52/02; H04W 24/02; H04W 76/15

(52) U.S. Cl. CPC H04W 52/0235; H04W 24/02; H04W 76/15

(57) ABSTRACT

A non-access point (AP) multi-link device (MLD) in a wireless network, the non-AP MLD comprising a memory, and a processor coupled to the memory, the processor configured to receive a first frame from an AP MLD indicating a recommendation for a number of simultaneous links, and transmit a second frame to the AP MLD indicating whether or not the non-AP MLD intends to follow the recommendation.

### CROSS-REFERENCE TO RELATED APPLICATIONS

This application claims the benefit of priority from U.S. Provisional Application No. 63/543,857, entitled “SIMULTANEOUS LINK OPERATION PROCEDURES FOR MULTI-LINK DEVICES” filed Oct. 12, 2023, which is incorporated herein by reference in its entirety.

### TECHNICAL FIELD

This disclosure relates generally to a wireless communication system, and more particularly to, for example, but not limited to, simultaneous link operation for multi-link devices.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a non-access point (AP) multi-link device (MLD) in a wireless network. The non-AP MLD comprises a memory and a processor coupled to the memory. The processor is configured to receive a first frame from an AP MLD indicating a recommendation for a number of simultaneous links. The processor is configured to transmit a second frame to the AP MLD indicating whether or not the non-AP MLD intends to follow the recommendation.

In some embodiments, the second frame indicates one or more links on which the non-AP MLD intends to be in an active mode or a power save mode, and a number of the one or more links is less than or equal to the recommended number of simultaneous links.

In some embodiments, the second frame is transmitted on one or more links on which the non-AP MLD intends to stay in an active mode or power save mode, and a number of the one or more links is less than or equal to the recommended number of simultaneous links.

In some embodiments, the second frame indicates that the non-AP MLD does not intend to follow the recommendation and the non-AP MLD is in an active mode or in a power save mode on a number of one or more links that is greater than the recommended number of simultaneous links.

In some embodiments, the second frame is transmitted on one or more links on which the non-AP MLD intends to stay in an active mode or a power save mode, and a number of the one or more links is greater than the recommended number of simultaneous links.

In some embodiments, the processor is further configured to receive at a later time a third frame from the AP MLD indicating an updated recommended number of simultaneous links that indicates a different value from the recommend number of simultaneous links in the first frame.

In some embodiments, the processor is further configured to set a critical update flag field in a beacon frame or a probe response frame to provide an indication of a critical update.

In some embodiments, the second frame indicates that the non-AP MLD does not intend to follow the recommendation and indicates an actual number of simultaneous links the non-AP MLD intends to use for communication with the AP MLD.

One aspect of the present disclosure provides an access point (AP) multi-link device (MLD) in a wireless network. The AP MLD comprises a memory, and a processor coupled to the memory. The processor is configured to transmit a first frame to a non-AP MLD indicating a recommendation for a number of simultaneous links. The processor is configured to receive a second frame from the non-AP MLD indicating whether or not the non-AP MLD intends to follow the recommendation.

In some embodiments, the second frame indicates one or more links on which the non-AP MLD intends to be in an active mode or a power save mode, and a number of the one or more links is less than or equal to the recommended number of simultaneous links.

In some embodiments, the second frame is received on one or more links on which the non-AP MLD intends to stay in an active mode or power save mode, and a number of the one or more links is less than or equal to the recommended number of simultaneous links.

In some embodiments, the second frame indicates that the non-AP MLD does not intend to follow the recommendation and that the non-AP MLD is in an active mode or in a power save mode on a number of one or more links that is greater than the recommended number of simultaneous links.

In some embodiments, the second frame is received on one or more links on which the non-AP MLD intends to stay in an active mode or a power save mode, and a number of the one or more links is greater than the recommended number of simultaneous links.

In some embodiments, the processor is further configured to transmit at a later time a third frame to the non-AP MLD indicating an updated recommended number of simultaneous links that indicates a different value from the recommend number of simultaneous links in the first frame.

In some embodiments, the processor is further configured to set a critical update flag field in a beacon frame or a probe response frame to provide an indication of a critical update.

In some embodiments, the second frame indicates that the non-AP MLD does not intend to follow the recommendation and indicates an actual number of simultaneous links the non-AP MLD intends to use for communication with the AP MLD.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates multi-link discovery and setup in accordance with an embodiment.

FIG. 5 illustrates a recommended max simultaneous link subfield in a basic multi-link element in accordance with an embodiment.

FIG. 6 illustrates a basic multi-link element with a recommended max simultaneous links field in accordance with an embodiment.

FIG. 7 illustrates a multi-link element with a preferred max simultaneous links subfield in accordance with an embodiment.

FIG. 8 illustrates a flow chart of an example process of communicating a maximum number of simultaneous links in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

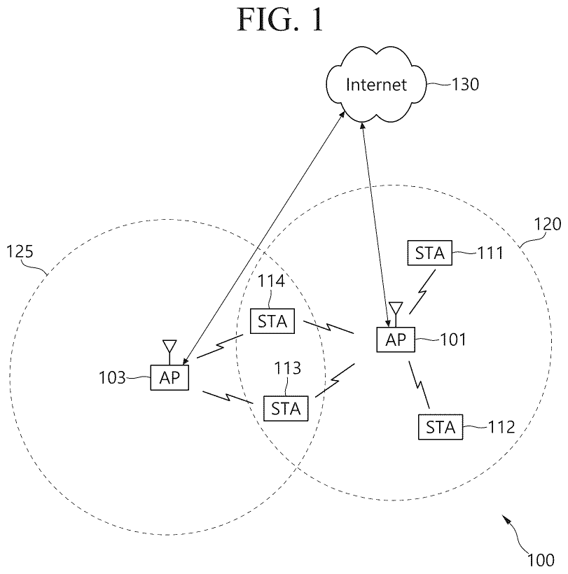

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

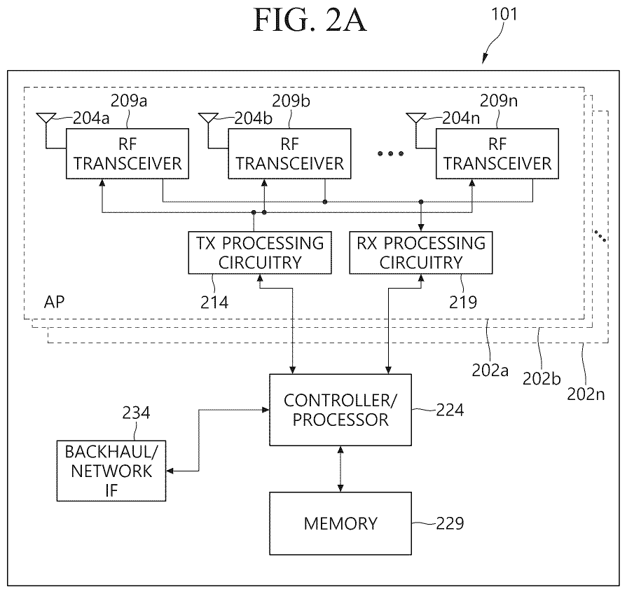

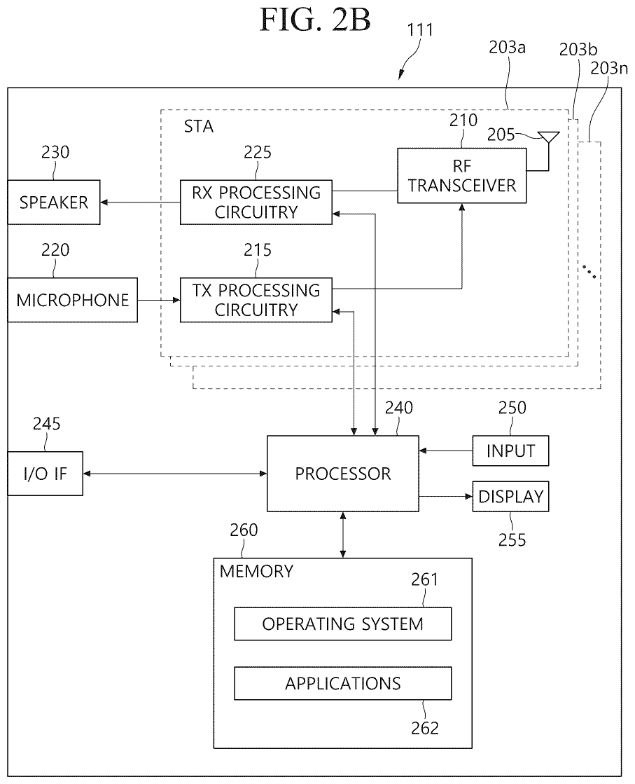

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

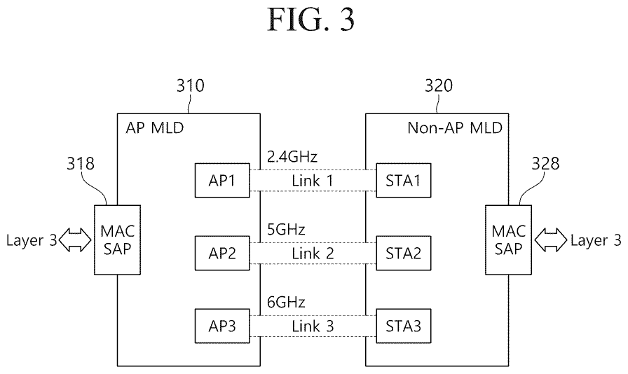

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.” Multi-link operation may allow the discovery and setup of multiple links between an AP MLD and a non-AP MLD, where the discovery or the setup can take place over a single link.

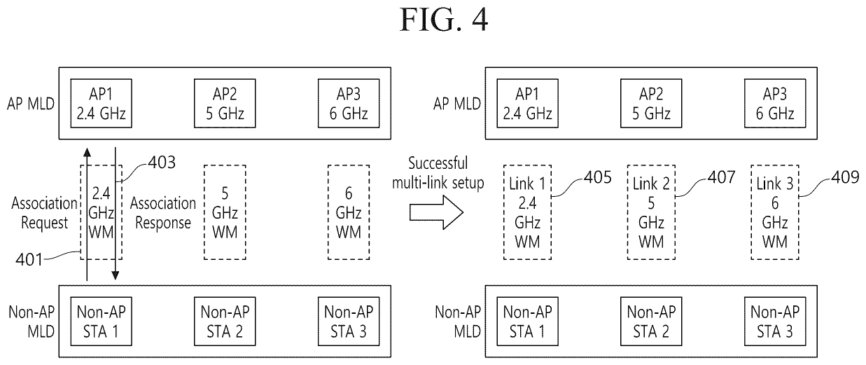

FIG. 4 illustrates multi-link discovery and setup in accordance with an embodiment. In particular, FIG. 4 illustrates an AP MLD communicating with a non-AP MLD. As illustrated, AP MLD is associated with AP1, AP2 and AP3, and non-AP MLD is associated with non-AP STA1, non-AP STA 2, and non-AP STA3. The non-AP MLD transmits an association request frame 401 to AP MLD. AP MLD then transmits an association response frame 403 to non-AP MLD. In FIG. 4, the association request frame 401 and the association response frame takes place over the 2.4 GHz link between the AP MLD and a non-AP MLD, where the setup is for establishing three links between the AP MLD and the non-AP MLD: one link on the 2.4 GHz band, a second link on the 5 GHz band, and a third link on the 6 GHz band. After the successful setup, the three links, including link 1 at 2.5 GHz 405, link 2 at 5 GHz 407, and link 3 at 6 GHz 409, are established between the AP MLD and the non-AP MLD.

The IEEE 802.11be specification provides for a maximum number of simultaneous links for MLO. With this, the AP can advertise through beacon and probe response frames the maximum number of simultaneous links the AP can support for each associated non-AP MLD. In order to make such an indication, the AP may set a recommended max simultaneous links subfield in a common info field of a basic multi-link element it includes in the beacon and/or probe response frames it transmits.

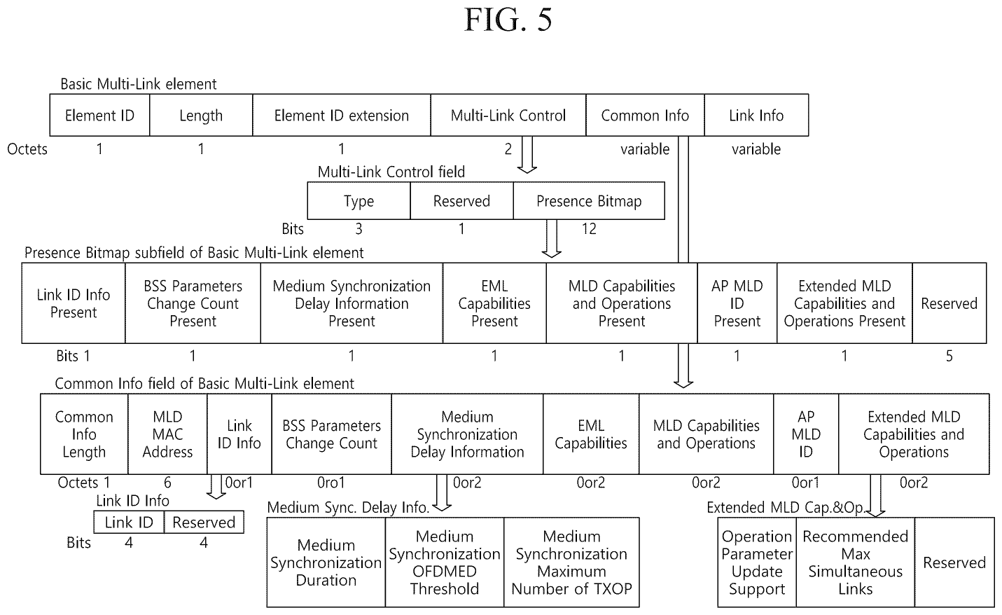

FIG. 5 illustrates a basic multi-link element in accordance with an embodiment. An associated non-AP MLD that receives such an indication from the AP MLD is recommended to not transmit to the AP MLD simultaneously over more than the value indicated in the recommended max simultaneous links subfield in the basic multi-link element. FIG. 5 illustrates a recommended max simultaneous link subfield in a basic multi-link element in accordance with an embodiment. As illustrated, the basic multi-link element may include an element ID field, a length field, an element ID extension field, a multi-link control field, a common info field, and a link info field. The element ID may include an identifier for the element. The length may include length information for the element. The element ID extension may include extension information for the element. The multi-link control field may include link control information, and can include several subfields, including a type field, a reserved field and a presence bitmap field.

The common info field can include common information and can include several subfields including a common info length field, a MLD MAC address field, a link ID info field, a basis service set (BSS) parameters change count field, a medium synchronization delay information field, an enhanced multi-link (EML) capabilities field, an MLD capabilities and operations field, an AP MLD ID field, and an extended MLD capabilities and operations field.

The link ID info field can include several subfields including a link ID field and a reserved field. The medium synchronization delay information field can include medium synchronization delay information and may include several subfields, including a medium synchronization duration field, a medium synchronization OFDM ED threshold field, and a medium synchronization maximum number of TXOP field. The extended MLD capabilities and operations field can include extended MLD capabilities and operations information and can include several subfields, including an operation parameter update support field, a recommended max simultaneous links field, and a reserved field.

Referring back to the link info field of the basic multi-link element, the link info field can include link information for the element. The type field can include type information for the multi-link control field. The reserved field may be reserved. The presence bitmap field can provide link information within the various subfields. In particular, the presence bitmap field can include a link ID info present field, a BSS parameters change count present field, a medium synchronization delay information present field, an EML capabilities present field, an MLD capabilities and operations present field, an AP MLD ID present field, an extended MLD capabilities and operations present field and a reserved field.

The link ID info present field can provide link ID information. The BSS parameters change count present can provide information regarding BSS parameters. The medium synchronization delay information present field can provide medium synchronization delay information. The EML capabilities present field can provide EML capabilities information. The MLD capabilities and operations present field can provide MLD capabilities and operations information and can include several subfields as described below. The AP MLD ID present field can include AP MLD identifier information. The extended MLD capabilities and operations field can provide MLD capabilities and operations information. The reserved field may be reserved.

The MLD capabilities and operations present field can include the various subfields. In particular, the common info length field can provide length information of the common info field of the basis multi-link element. The MLD MAC address field can provide MAC address information. The link ID info field can provide link ID information and can include a link ID subfield and a reserved subfield. The link ID subfield may provide an identifier information. The reserved field may be reserved. The BSS parameters change count field may provide BSS parameters information. The medium synchronization delay information field may provide delay information and can include a medium synchronization duration field, a medium synchronization OFDM ED threshold field, and a medium synchronization maximum number of TXOP fields. The medium synchronization duration field may provide duration information. The medium synchronization OFDM ED threshold may provide OFDM ED threshold information. The medium synchronization maximum number of TXOP may provide a maximum number of TXOP information.

The EML capabilities field may provide EML capabilities information. The MLD capabilities and operations field may provide MLD capabilities and operations information. The AP MLD ID field may provide an AP MLD identifier information. The extended MLD capabilities and operations field may provide extended MLD capabilities and operations information and can include an operation parameter update support field, a recommended max simultaneous links field and a reserved field. The operation parameter update support field can include operation parameter update support information. The recommended max simultaneous links field may provide a recommended maximum number of enabled links that a non-AP MLD can operate on for simultaneous frame exchanges and the reserved field may be reserved.

According to the existing standards, the recommended max simultaneous links subfield is not present in the basic multi-link element if the basic multi-link element is carried in any frame other than the beacon frame and probe response frames. In other words, the recommended max simultaneous links subfield is not included in the basic multi-link element if the basic multi-link element is transmitted by a non-AP MLD.

In some embodiments, upon receiving a recommendation from the AP MLD on the maximum number of simultaneous links in the beacon frame and/or probe response frame, an associated non-AP MLD can either obey the recommendation or disobey the recommendation. If the non-AP MLD decides to obey the recommendation, then the non-AP MLD can indicate to the associated AP MLD that it is in an active mode or in the power save mode on the number of links equal or less than the value indicated in the recommended max simultaneous links subfield in the basic multi-link element. In order to make such an indication, the non-AP MLD can send a frame with the power management (PM) bit set to 1 on the desired links on which the non-AP MLD intends to stay in the active mode or the power save mode and receive services from the AP MLD. In certain embodiments, the non-AP MLD may send PS-Poll frame or QoS Null frames on the desired links on which the non-AP MLD intends to stay in the active mode or the power save mode and receive services from the AP MLD.

In some embodiments, upon receiving a recommendation from the AP MLD on the maximum number of simultaneous links in the beacon frame and/or probe response frame, if the associated non-AP MLD decides to disobey the recommendation, then the non-AP MLD can indicate to the associated AP MLD that it is in active mode or in the power save mode on the number of links greater than the value indicated in the recommended max simultaneous links subfield in the basic multi-link element. In order to make such an indication, the non-AP MLD can send a frame with the PM bit set to 1 on the desired links on which the non-AP MLD intends to stay in active mode or power save mode and receive services from the AP MLD. In certain embodiments, the non-AP MLD may send PS-Poll frames or QoS Null frames on the desired links on which the non-AP MLD intends to stay in active mode or power save mode and receive services from the AP MLD.

In some embodiments, when a non-AP MLD receives a recommendation from the associated AP MLD on the maximum number of simultaneous links in the beacon frame and/or probe response frame, such recommendation can be interpreted in different ways. In particular, in some embodiments, the recommendation may be interpreted such that the AP MLD does not intend to transmit downlink physical layer protocol data units (PPDUs) or any downlink frames to the non-AP MLD simultaneously over more than the recommended number of maximum links, which can be indicated in the recommended max simultaneous links subfield in the basic multi-link element transmitted by the AP MLD.

In certain embodiments, the recommendation may be interpreted such that the AP MLD prefers that the non-AP MLD does not transmit any uplink PPDUs or uplink frames to the AP MLD simultaneously over more than recommended number of links, which can be indicated by the recommended max simultaneous links subfield in the basic multi-link element received from the AP MLD.

In some embodiments, the recommendation may be interpreted such that the AP MLD prefers that the non-AP MLD does not simultaneously use more links than the value indicated in the recommended max simultaneous links subfield in the basic multi-link element for either uplink or downlink or together uplink and downlink. Accordingly, the total number of links the non-AP MLD should be in active mode (or in the power save mode) simultaneously should not be more than the value indicated in the recommended max simultaneous links subfield in the basic multi-link element.

In some embodiments, by simultaneous transmission, it can mean that the non-AP MLD cannot transmit a frame, e.g., physical layer protocol data unit (PPDU), MAC protocol data unit (MPDU), Aggregated-MPDU (A-MPDU), physical layer service data unit (PSDU), to the AP MLD over more than one link where the frame transmitted over those multiple links overlaps in time, or their corresponding acknowledgement frame (ack or block ack) overlaps in time, or the frame in one link overlaps in time with an acknowledgement frame (ack/block-ack) over another link.

In some embodiments, the recommendation for the maximum number of simultaneous links, which can be indicated by the recommended max simultaneous links subfield in the basic multi-link element, by an AP MLD can change over time during the lifetime of the basic service set (BSS) of the APs affiliated with the AP MLD. In some embodiments, a non-AP MLD associated with the AP MLD, after association with the AP MLD, can receive a frame (for example, a first beacon frame) over any enabled or setup links between the AP MLD and the non-AP MLD with a first recommendation on the maximum number of simultaneous links that the AP MLD can use for transmitting to the non-AP MLD. At a later time, while still remaining associated with the AP MLD, the non-AP MLD can receive a second frame (for example, a second beacon frame) with a second recommendation on the maximum number of simultaneous links from the same associated AP MLD, where the first recommendation and the second recommendation can indicate different values for the recommended maximum number of simultaneous links. In some embodiments, the value of the recommended max simultaneous links subfield in the basic multi-link element in a first beacon frame and the value of the recommended max simultaneous links subfield in the basic multi-link element in a second beacon frame can be different.

In some embodiments, when the AP MLD changes the value in the recommended max simultaneous links subfield in the basic multi-link element, it may be treated as a critical update. In some embodiments, the AP MLD may set a Critical Update Flag field of a Capability Information and Status Indication field to 1 in a Beacon frame and/or Probe response frame to provide an indication of a critical update. In some embodiments, the Critical Update Flag on any links of the AP MLD can be set to 1, and the corresponding BSS parameter change count subfield can be incremented.

In some embodiments, the recommendation for the maximum number of simultaneous links, which can be indicated by the recommended max simultaneous links subfield in the basic multi-link element by an AP MLD, may remain the same over time during the lifetime of the BSS of the APs affiliated with the AP MLD. In some embodiments, a non-AP MLD associated with the AP MLD, after association with the AP MLD, can receive a frame (for example, a first beacon frame) over any enabled or setup links between the AP MLD and the non-AP MLD with a first recommendation on the maximum number of simultaneous links that the AP MLD can use for transmitting to the non-AP MLD. At a later time, while still remaining associated with the AP MLD, the non-AP MLD can receive a second frame (for example, a second beacon frame) with a second recommendation on the maximum number of simultaneous links from the same associated AP MLD, where the first recommendation and the second recommendation can indicate the same value for the recommended maximum number of simultaneous links. In some embodiments, the value of the recommended max simultaneous links subfield in the basic multi-link element in a first beacon frame and the value of the recommended max simultaneous links subfield in the basic multi-link element in a second beacon frame can be the same.

In some embodiments, when a non-AP MLD receives a recommendation from the associated AP MLD on the maximum number of simultaneous links in the beacon frame and/or probe response frame (for example, by the value indicated in the recommended max simultaneous links subfield in the basic multi-link element received from the AP MLD), the non-AP MLD can indicate to the AP MLD whether the non-AP MLD can obey or follow the recommendation or not. Such indication can be made by the non-AP MLD in various different ways as described below.

In some embodiments, the non-AP MLD can send a frame to the AP MLD over one or more of the enabled or setup links between the AP MLD and the non-AP MLD. In this frame, there can be an element which can include an indication regarding whether the non-AP MLD will follow the recommendation or not. This indication can be made using a single bit field in that element. If that bit is set to 1, it can indicate that the non-AP MLD intends to obey the recommendation from the AP MLD. If that bit is set to 0, it can indicate that the non-AP MLD does not intend to obey the recommendation (i.e., the non-AP MLD intends to use more links than the value indicated in the recommended max simultaneous links subfield in the basic multi-link element received from the AP MLD). The field can be in the basic multi-link element or reconfiguration multi-link element that the non-AP MLD transmits to the AP MLD. In some embodiments, the non-AP MLD can send a basic multi-link element to the AP MLD over one or more of the enabled or setup links between the AP MLD and the non-AP MLD. The basic multi-link element can have a field named obey recommended max simultaneous links in the extended MLD capabilities and operations subfield.

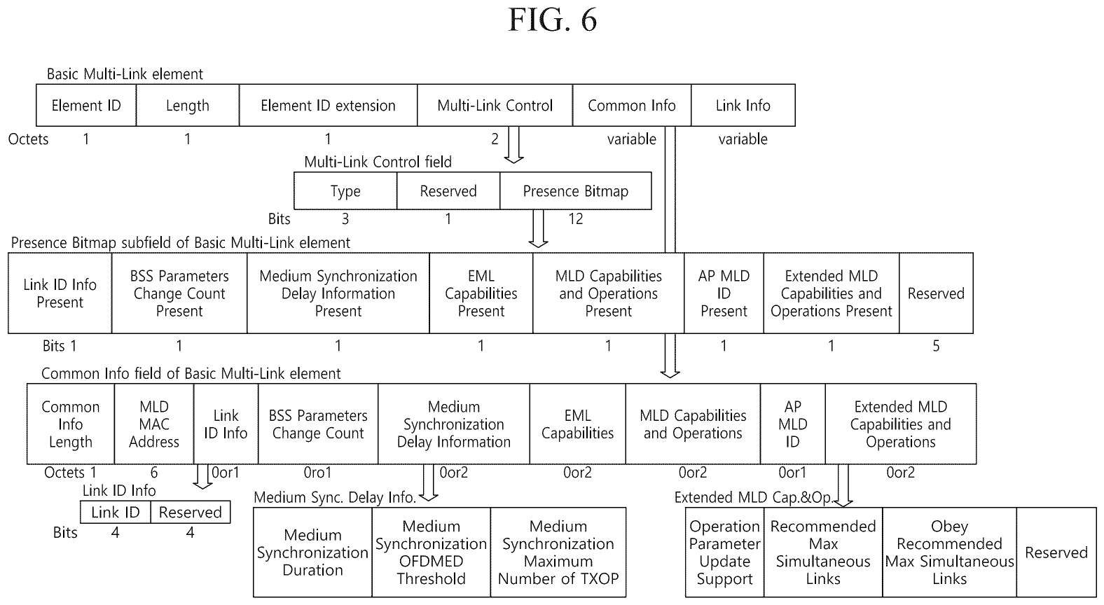

FIG. 6 illustrates a basic multi-link element with a recommended max simultaneous links field in accordance with an embodiment. The fields illustrated in FIG. 6 may be the same or similar to those illustrated in FIG. 5. However, as illustrated in FIG. 6, the extended MLD capabilities and operations field may also include an obey recommended max simultaneous links field which can provide an indication regarding whether the non-AP MLD intends or does not intend to obey a recommendation. In some embodiments, when the basic multi-link element is transmitted by an AP MLD, the obey recommended max link subfield shall be treated as reserved. When a non-AP MLD is transmitting the basic multi-link element, the obey recommended max simultaneous link subfield shall be included with a value.

In particular, if the obey recommended max simultaneous links subfield is set to 1, then it can indicate that the non-AP MLD intends to obey the recommendation from the AP MLD; if the obey recommended max simultaneous links subfield is set to 0, then it can indicate that the non-AP MLD does not intend to obey the recommendation from the AP MLD.

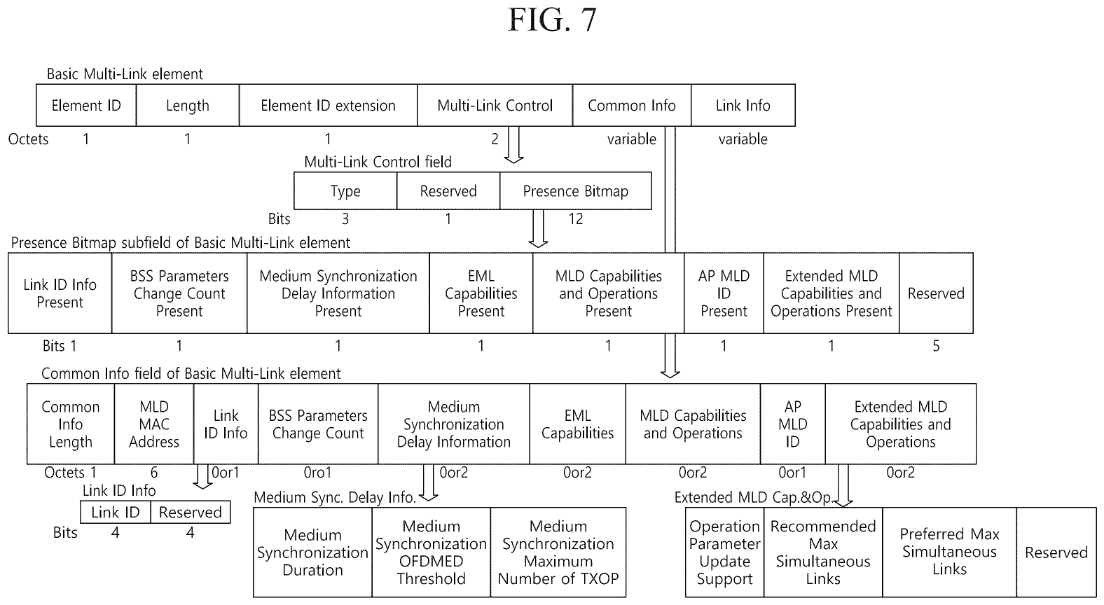

In some embodiments, if the non-AP MLD does not intend to follow the recommendation from the AP MLD, then the non-AP MLD can also indicate the value of simultaneous links that the non-AP MLD intends or prefers to use using a field in the basic multi-link element it transmits to the AP MLD. In some embodiments, the basic multi-link element or the reconfiguration multi-link element can have a preferred max simultaneous links subfield, which can indicate the actual number of simultaneous links the non-AP MLD intends to use for communication with the AP MLD, as illustrated in FIG. 7 in accordance with an embodiment. In particular, FIG. 7 illustrates a multi-link element with a preferred max simultaneous links subfield in accordance with an embodiment. The fields of the multi-link element illustrated in FIG. 7 are the same as those described in FIG. 6, with the difference being the obey recommended max simultaneous links subfield. In some embodiments, a recommended max simultaneous links subfield, which may be currently reserved in a basic multi-link element transmitted by the non-AP MD, can be repurposed. In some embodiments, when a non-AP MLD transmits a basic multi-link element to the AP MLD, the recommended max simultaneous links subfield in the basic multi-link element can indicate the number of maximum simultaneous links the non-AP MLD intends to use for communication with the AP MLD. In some embodiments, the recommended max simultaneous Links subfield can indicate the maximum simultaneous links for downlink frame transmission. In some embodiments, the recommended max simultaneous links subfield can indicate the maximum simultaneous links for uplink frame transmission. Such indication can be made in a setup response frame, probe response frame, and/or a separate new frame. In some embodiments, upon receiving such indication from the non-AP MLD, the AP MLD can send a confirmation frame to the non-AP MLD indicating the acceptance/rejection of the non-AP MLD's intention.

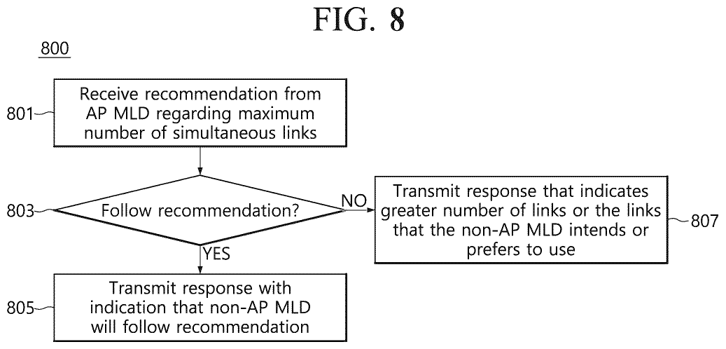

FIG. 8 illustrates a flow chart of an example process of communicating a maximum number of simultaneous links in accordance with an embodiment. Although one or more operations are described or shown in particular sequential order, in other embodiments the operations may be rearranged in a different order, which may include performance of multiple operations in at least partially overlapping time periods. The flowchart depicted in FIG. 8 illustrates operations performed in an a non-AP MLD, such as non-AP MLD illustrated in FIG. 3.

The process 800, in operation 801, receives a recommendation from an AP MLD regarding a maximum number of simultaneous links. In some embodiments, the recommendation may be included in a Beacon frame and/or Probe Response frame. In some embodiments, a recommendation may indicate that the AP MLD does not intend to transmit downlink PPDUs or any downlink frames to the non-AP MLD simultaneously over more than the recommended number of maximum links. In some embodiments, a recommendation may indicate that the AP MLD prefers that the non-AP MLD does not transmit any uplink PPDUs or uplink frames to the AP MLD simultaneously over more than a recommended number of links. In some embodiments, a recommendation may indicate that the AP MLD prefers the non-AP MLD does not simultaneously use more links than a recommended maximum number of links for either uplink or downlink or together uplink and downlink.

In operation 803, the process determines whether it intends to follow the recommendation. If in operation 803, the process determines that it does intend to follow the recommendation, then in operation 805, the process transmits a response to the AP MLD with an indication that the non-AP MLD will follow the recommendation. In some embodiments, if the non-AP MLD decides to obey the recommendation, then the non-AP MLD can indicate to the associated AP MLD that it is in active mode or in the power save mode on the number of links equal or less than the value indicated in the Recommended Max Simultaneous Links subfield in the Basic Multi-Link element. In order to make such an indication, the non-AP MLD can send any frame with the PM bit set to 1 on the desired links on which the non-AP MLD intends to stay in active mode or power save mode and receive services from the AP MLD. In certain embodiments, the non-AP MLD may send PS-Poll frames or QoS Null frames on the desired links to the non-AP MLD intends to stay in active mode or power save mode.

If in operation 803, the process determines that it does not intend to follow the recommendation, then in operation 807, the process transmits a response that indicates a greater number of simultaneous links and/or provides information regarding the links that the non-AP MLD intends or prefers to use. In some embodiments, if the associated non-AP MLD decides to disobey the recommendation, then the non-AP MLD can indicate to the associated AP MLD that it is in active mode or in the power save mode on the number of links greater than the value indicated in the Recommended Max Simultaneous Links subfield in the Basic Multi-Link element. In order to make such an indication, the non-AP MLD can send any frame with the PM bit set to 1 on the desired links on which the non-AP MLD intends to stay in active mode or power save mode and receive services from the AP MLD. In certain embodiments, the non-AP MLD may send PS-Poll frames or QoS Null frames on the desired links to the non-AP MLD intends to stay in active mode or power save mode. In some embodiments, if the non-AP MLD does not intend to follow the recommendation from the AP MLD, then the non-AP MLD can also indicate the value of simultaneous links that the non-AP MLD intends or prefers to use using a field in the Basic Multi-Link element it transmits to the AP MLD.

Embodiments in accordance with this disclosure provide rules and operational procedures that allow an AP to change a recommended maximum number of simultaneous links during the lifetime of a BSS, providing flexibility for an AP to reconfigure network operations as needed based on changing traffic conditions. Furthermore, an AP may obtain knowledge of whether or not a non-AP MLD intends to follow a recommendation or not, which can provide for better traffic and link management between associated non-AP MLDs. Likewise, a non-AP MLD may use information regarding a recommended number of simultaneous links provided by an AP in deciding whether or not to associate with the AP MLD.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) in a wireless network, the non-AP MLD comprising:
a memory; and
a processor coupled to the memory, the processor configured to:
receive a first frame from an AP MLD indicating a recommendation for a number of simultaneous links; and
transmit a second frame to the AP MLD indicating whether or not the non-AP MLD intends to follow the recommendation.

2. The non-AP MLD of claim 1, wherein:
the second frame indicates one or more links on which the non-AP MLD intends to be in an active mode or a power save mode; and
a number of the one or more links is less than or equal to the recommended number of simultaneous links.

3. The non-AP MLD of claim 1, wherein:
the second frame is transmitted on one or more links on which the non-AP MLD intends to stay in an active mode or power save mode; and
a number of the one or more links is less than or equal to the recommended number of simultaneous links.

4. The non-AP MLD of claim 1, wherein the second frame indicates that the non-AP MLD does not intend to follow the recommendation and the non-AP MLD is in an active mode or in a power save mode on a number of one or more links that is greater than the recommended number of simultaneous links.

5. The non-AP MLD of claim 1, wherein:
the second frame is transmitted on one or more links on which the non-AP MLD intends to stay in an active mode or a power save mode; and
a number of the one or more links is greater than the recommended number of simultaneous links.

6. The non-AP MLD of claim 1, wherein the processor is further configured to:
receive at a later time a third frame from the AP MLD indicating an updated recommended number of simultaneous links that indicates a different value from the recommend number of simultaneous links in the first frame.

7. The non-AP MLD of claim 5, wherein the processor is further configured to set a critical update flag field in a beacon frame or a probe response frame to provide an indication of a critical update.

8. The non-AP MLD of claim 1, wherein the second frame indicates that the non-AP MLD does not intend to follow the recommendation and indicates an actual number of simultaneous links the non-AP MLD intends to use for communication with the AP MLD.

9. An access point (AP) multi-link device (MLD) in a wireless network, the AP MLD comprising:
a memory; and
a processor coupled to the memory, the processor configured to:
transmit a first frame to a non-AP MLD indicating a recommendation for a number of simultaneous links; and
receive a second frame from the non-AP MLD indicating whether or not the non-AP MLD intends to follow the recommendation.

10. The AP MLD of claim 9, wherein:
the second frame indicates one or more links on which the non-AP MLD intends to be in an active mode or a power save mode; and
a number of the one or more links is less than or equal to the recommended number of simultaneous links.

11. The AP MLD of claim 9, wherein:
the second frame is received on one or more links on which the non-AP MLD intends to stay in an active mode or power save mode; and
a number of the one or more links is less than or equal to the recommended number of simultaneous links.

12. The AP MLD of claim 9, wherein the second frame indicates that the non-AP MLD does not intend to follow the recommendation and that the non-AP MLD is in an active mode or in a power save mode on a number of one or more links that is greater than the recommended number of simultaneous links.

13. The AP MLD of claim 9, wherein:
the second frame is received on one or more links on which the non-AP MLD intends to stay in an active mode or a power save mode; and
a number of the one or more links is greater than the recommended number of simultaneous links.

14. The AP MLD of claim 9, wherein the processor is further configured to:
transmit at a later time a third frame to the non-AP MLD indicating an updated recommended number of simultaneous links that indicates a different value from the recommend number of simultaneous links in the first frame.

15. The AP MLD of claim 14, wherein the processor is further configured to set a critical update flag field in a beacon frame or a probe response frame to provide an indication of a critical update.

16. The AP MLD of claim 9, wherein the second frame indicates that the non-AP MLD does not intend to follow the recommendation and indicates an actual number of simultaneous links the non-AP MLD intends to use for communication with the AP MLD.

17. A computer-implemented method for communication by a non-access point (AP) multi-link device (MLD) in a wireless network, the method comprising:
receiving a first frame from an AP MLD indicating a recommendation for a number of simultaneous links; and
transmitting a second frame to the AP MLD indicating whether or not the non-AP MLD intends to follow the recommendation.

18. The computer-implemented method of claim 17, wherein:
the second frame indicates one or more links on which the non-AP MLD intends to be in an active mode or a power save mode; and
a number of the one or more links is less than or equal to the recommended number of simultaneous links.

19. The computer-implemented method of claim 17, wherein:
the second frame is transmitted on one or more links on which the non-AP MLD intends to stay in an active mode or power save mode; and
a number of the one or more links is less than or equal to the recommended number of simultaneous links.

20. The computer-implemented method of claim 17, wherein the second frame indicates that the non-AP MLD does not intend to follow the recommendation and the non-AP MLD is in an active mode or in a power save mode on a number of one or more links that is greater than the recommended number of simultaneous links.
